(19) United States
(12) Patent Application Publication
(10) Pub. No.: US 2019/0352144 A1
(43) Pub. Date: Nov. 21, 2019

(54) MOVABLE HOISTING APPARATUS, ARRANGEMENT AND METHOD

(71) Applicant: KONECRANES GLOBAL CORPORATION, Hyvinkää (FI)

(72) Inventors: Toni HUUSKO, Hyvinkää (FI); Olli KUISMANEN, Akaa (FI); Janne SALOMÄKI, Hyvinkää (FI)

(73) Assignee: KONECRANES GLOBAL CORPORATION, Hyvinkää (FI)

(21) Appl. No.: 16/479,321

(22) PCT Filed: Jan. 30, 2018
(86) PCT No.: PCT/FI2018/050068

§ 371 Date: Jul. 19, 2019

(30) Foreign Application Priority Data
Jan. 30, 2017 (FI) 20175080

(51) Int. Cl. B66C 13/48; B66C 13/46; G05D 1/02; G06T 7/246; G06T 7/73

(52) U.S. Cl. CPC B66C 13/48; B66C 13/46; G05D 1/0253; B66C 19/005; G06T 7/73; G05D 2201/0216; G06T 7/248

(57) ABSTRACT

An arrangement in connection with a movable hoisting apparatus includes at least one imaging device and a processor provided in connection with the movable hoisting apparatus. The imaging device is adapted to save images which at least partly present the surroundings of the hoisting apparatus. The processor is adapted to identify at least one identifiable object from at least two images saved at different time instants and to determine the direction and speed of travel of the hoisting apparatus based on the position of the identifiable object in the images.

### BACKGROUND OF THE INVENTION

The invention relates to a hoisting apparatus and a method in connection with the movable hoisting apparatus.

In connection with the use and control of movable hoisting apparatuses, travel and position data of the hoisting apparatus is needed for various purposes, such as for controlling the moving of the hoisting apparatus and for load handling.

In known solutions, travel and position data of a hoisting apparatus is determined by means of, for example, transmitters provided at predetermined intervals, such as every 10 metres, on the route of the hosting apparatus, and readers identified on support legs of the hoisting apparatus, whereby the hoisting apparatus is able to identify the position of the support legs and travelling speed when passing these transmitters, or by GPS positioning with the use of local compensation. However, these methods are very expensive.

### BRIEF DESCRIPTION OF THE INVENTION

An object of the invention is thus to provide a method and equipment implementing the method so as to solve the aforementioned problems. The object of the invention is achieved by a method and system which are characterized by what is disclosed in the independent claims. Preferred embodiments of the invention are disclosed in the dependent claims.

The invention is based on utilizing at least one imaging device provided in connection with the hoisting apparatus, and objects identified from images it has produced and/or saved for determining at least the speed and direction of the travel of the hoisting apparatus.

The advantages of the method and arrangement according to the invention are, for example, that by means of cameras or other imaging devices possible already provided in connection with a hoisting apparatus, the travel speed and direction of the hoisting apparatus may advantageously and even without additional costs be determined.

### BRIEF DESCRIPTION OF THE FIGURES

The invention will now be described in more detail in connection with preferred embodiments and with reference to the accompanying drawings, in which:

FIG. 1 is a schematic view of a movable hoisting apparatus;

FIG. 2 is a schematic view of an arrangement in connection with a movable hoisting apparatus;

FIGS. 3a and 3b are schematic views of images saved by an imaging device at two different instants of time; and

FIG. 4 show a method in connection with a movable hoisting apparatus.

### DETAILED DESCRIPTION OF THE INVENTION

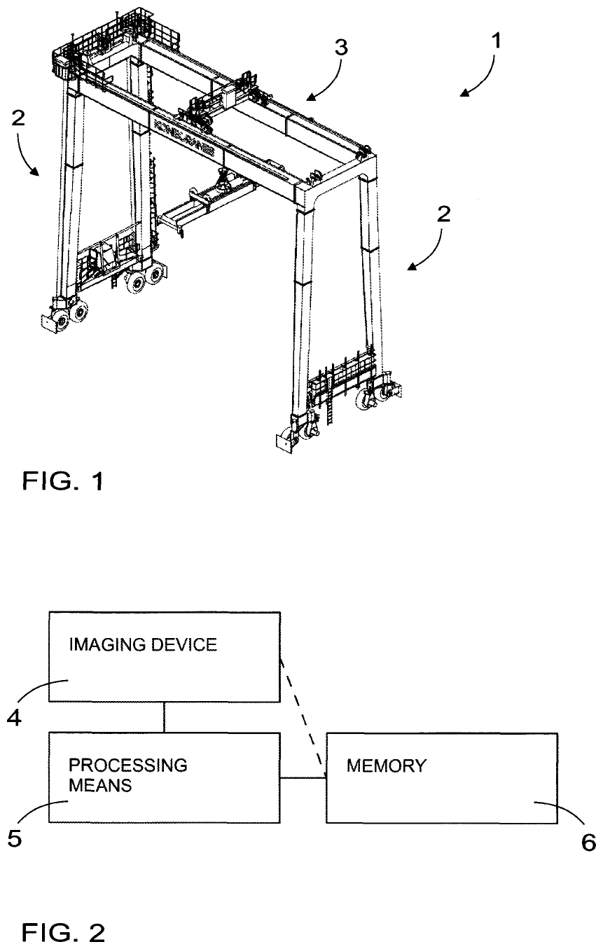

FIG. 1 is a schematic view of a movable hoisting apparatus. A movable hoisting apparatus may comprise, for example, a portal crane such as a Bridge Crane, or if electrically operated, also an Electric Overhead Travelling crane, which are intended to move along rails raised above ground level, a Rail Mounted Gantry Crane (RMG) intended to move along rails provided at ground level, or a hoisting apparatus provided with rubber tires, such as a Gantry Crane, Rubber Tired Gantry Crane (RTG), or a straddle carrier. A movable hoisting apparatus therefore refers to a hoisting apparatus, which in its entirety may be moved in relation to the operating environment and running platform. The moving may take place on, for example, rails or a running platform such as the ground or floor. In different embodiments, such movable hoisting apparatuses may be used indoors and/or outdoors. The hoisting apparatus shown in FIG. 1 comprises a gantry crane, but the disclose solution is suited to hoisting apparatuses of other kinds as well.

Movable hoisting apparatus 1, portal cranes in particular, typically comprise at least one, but often at least two vertical support structures 2 which act as the (support) legs of the hoisting apparatus. A horizontal support structure 3 serves as the bridge of the hoisting apparatus, extending between the vertical support structures. The bridge may be used in load handling above the load handling area, for instance for picking up loads or lowering them into different positions between the legs of the hoisting apparatus. The vertical support structures and the horizontal support structures of the hoisting apparatus may comprise internal support structures which are horizontal, vertical or diagonal. Examples of internal support structures include access bridges, railings and girders.

FIG. 2 is a schematic view of an arrangement in connection with a movable hoisting apparatus. The arrangement in connection with the movable hoisting apparatus may comprise at least one imaging device and at least one processing means 5 provided in connection with at least one hoisting apparatus 1. The imaging device 4 may comprise a device which is adaptable to produce and/or save data in an image form, that is, image data, such as images. The imaging device may be adapted to save the images of image data as image files consisting of image points, for example. The images may comprise still images and/or video image, for example. The images or image files may be saved into a memory 6.

The processing means 5 may comprise an apparatus consisting of one or more devices, which may be adapted to process the data that the hoisting apparatus 1 has gathered and to control the operation of the hoisting apparatus on the basis of the gathered data. The processing means 5 may be adapted to carry out at least some of the process steps and/or operations disclosed in this specification. The processing means 5 may comprise a programmable logic and/or programmable microprocessor, for example. The processing means 5 may comprise a control unit of the hoisting apparatus, or a part thereof. The processing means may be adapted to save at least image data and time data related to the image data into the memory 6, which may comprise volatile memory or non-volatile memory, such as EEPROM, ROM, PROM, RAM, DRAM, SRAM, firmware and/or programmable logic, and to retrieve image data from the memory for operations related to definition and calculation. The memory 6 may comprise a memory of the imaging device, that is, a memory provided as a part of the imaging device or in connection with the imaging device, a memory of the processing means, that is, a memory provided as a part of the processing means or in connection with the processing means, or another suitable memory.

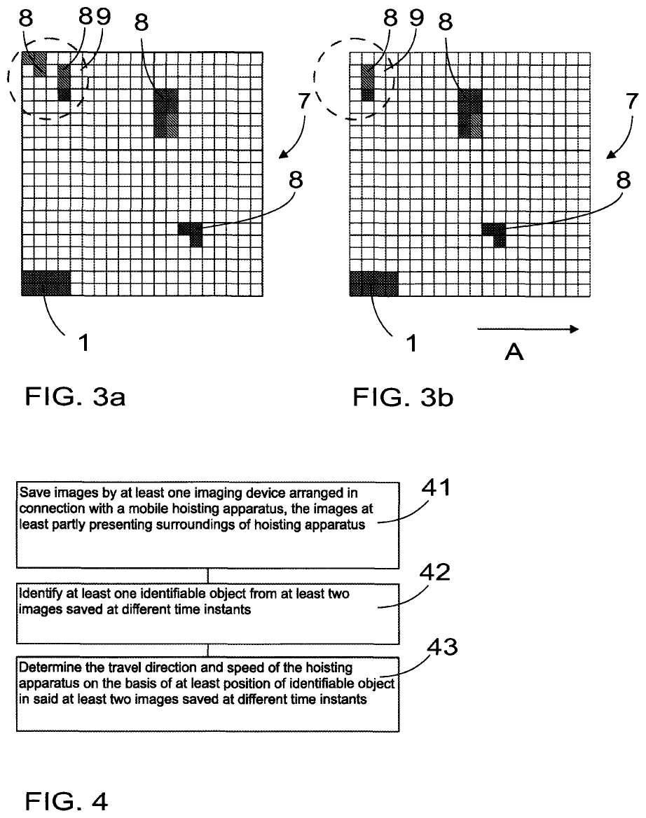

FIGS. 3a and 3b are schematic views of images 7 saved by the imaging device 4 at two different instants of time. The images 7 shown in FIGS. 3a and 3b are only meant to illustrate the present solution, and in different embodiments the content and method of presentation of the images 7 may significantly differ from what is shown in FIGS. 3a and 3b. The grid, for example, shown in FIGS. 3a and 3b is only intended to illustrate the image area, and the images or their parts are not shown in scale.

In the arrangement in connection with a movable hoisting apparatus, at least one imaging device 4 may be adapted to save images 7, which at least partly present the surroundings of the hoisting apparatus. In other words, at least some of the image points of at least some of the images comprise data on the surroundings of the hoisting apparatus. So, the imaging device 4 may be adapted to produce and/or save images all of or at least some of the image points of which represent the surroundings of the hoisting apparatus. Therefore, some of the image points of the produced or saved images may present the hoisting apparatus 1 and/or parts thereof.

The processing means 5 may be adapted to identify at least one identifiable object 8 from at least two images 7 saved at different time instants and to determine the direction and speed of travel of the hoisting apparatus on the basis of at least the position of the identifiable object 8 in said at least two images 7 saved at different time instants. In other words, the processing means 5 may be adapted to identify at least one same identifiable object 8 from at least one first image 7 saved at a first time instant and from at least one second image 7 saved at a second time instant and to determine the direction and speed of travel of the hoisting apparatus based on at least the position of the identifiable object 8 in said first saved image and second saved image. In the various embodiments, there may naturally be more than two different time instants, images saved at different time instants, and objects identifiable from the saved images. Obviously, not all of the identifiable objects 8 need to be seen in all of the saved images.

In an embodiment, the processing means 5 may additionally be adapted to calculate the position data of the hoisting apparatus by integrating the determined speed of the hoisting apparatus. In other words, the position data of the hoisting apparatus may be determined on the basis of the speed of travel and changes in the speed of travel of the hoisting apparatus. The starting point may be a fixed, predetermined reference point, such as the starting or end point of the track of the hoisting apparatus, or a corner point or similar of a fixed structure located in the surroundings of the hoisting apparatus, or a relative point in a coordinate system describing the position of the hoisting apparatus.

In an embodiment, at least one identifiable object 8 may comprise an object not predefined. In other words, the identifiable object, the shape of the identifiable object or the position of the identifiable object need not be known in advance. In this case, identification may take place by automatic image recognition or on the basis of identification of a group of image points, at least some characteristics of which correspond to each other, in temporally consecutive images produced and/or saved with the same imaging device or produced and/or saved with different imaging devices. In other words, the size and/or density of the group of image points representing the identifiable object may change as the imaging device moves towards the identifiable object or away from it, or when the lighting conditions change, but the shape of the group of image points or its relative characteristics in relation to its surroundings may make it possible to identify the identifiable object.

In an embodiment, at least one identifiable object 8 may comprise a reference point known in advance. In other words, at least one identifiable object may comprise a stationary, known object. The processing means 5 may in such a case be adapted to search for such a reference point from the images 7 produced and/or saved by the imaging device. In an embodiment, the processing means 5 may be adapted to calibrate the position data of the hoisting apparatus by utilizing the identification of a reference point known in advance. In an embodiment, the processing means 5 may, for example, be adapted to calibrate the position of the hoisting apparatus 1 by determining the position of the hoisting apparatus in relation to an identified reference point, by determining the position of the hoisting apparatus on the basis of a previously determined position of the reference point and the determined mutual position of the reference point and the hoisting apparatus, as well as updating the position data of the hoisting apparatus 1 to match the position of the hoisting apparatus determined in this manner in response to identifying the reference point and/or the fulfilment of other criteria or group of criteria, such as identifying a reference point once a predetermined time has lapsed from the previous determination of the position of the hoisting apparatus.

In an embodiment, at least one of the identifiable objects 8 comprises a unique reference point whose position is unambiguously identifiable. In this case, the processing means 5 may be adapted to calibrate the position data of the hoisting apparatus 1 by utilizing the identification of the unique reference point and its known position in the usage environment of the hoisting apparatus. In an embodiment, the processing means 5 may, for example, be adapted to calibrate the position of the hoisting apparatus by determining the position of the hoisting apparatus in relation to a unique reference point, by determining the position of the hoisting apparatus on the basis of the known position of the unique reference point and the determined mutual position of the unique reference point and the hoisting apparatus, as well as updating the position data of the hoisting apparatus to match the position of the hoisting apparatus determined in this manner in response to identifying the unique reference point and/or the fulfilment of other criteria or group of criteria, such as identifying a reference point once a predetermined time has lapsed from the previous determination of the position of the hoisting apparatus. Thereby, the calibration of the position of the hoisting apparatus and consequently the accuracy of the position data of the hoisting apparatus may be further improved. In an embodiment, instead of one identifiable object, the unique reference point 9 may be formed by a group of identifiable objects 8.

FIGS. 3a and 3b show schematically an example where part of the hoisting apparatus 1 is seen both in a first image saved at a first time instant, schematically shown by FIG. 3a, and in a second image saved at a second time instant, schematically shown by FIG. 3b. Between the time instants, the hoisting apparatus 1 has moved in the direction of travel A, depicted by an arrow in FIG. 3b, by an amount corresponding to two squares in the figure. In this cased, the identifiable objects 8, of which there are four pieces in FIG. 3a and three pieces in FIG. 3b, have correspondingly moved to the left in the image 7 of the imaging device 4. In FIG. 3a, the two identifiable objects 8 seen on the left of FIG. 7, may constitute a group 9 of identifiable objects 8. Such a group of identifiable objects 9 may form, for example, a unique reference point or a group of identifiable objects of another kind. On the other hand, the identifiable object 8 may even as such comprise a group of parts, items, or objects located in a particular manner in relation to each other. To determine the direction and speed of travel of the hoisting apparatus, the data of those identifiable objects 8 may be used, which are identifiable in both in the first image saved at the first time instant and in the second image saved at the second time instant.

In an embodiment, the arrangement in connection with the hoisting apparatus may further comprise at least one identifiable object 8, identifiable on the basis of its graphical properties, provided on the running platform of the hoisting apparatus in the travel area of the hoisting apparatus in the vicinity of the route of the hoisting apparatus. In other words, in the surroundings of the hoisting apparatus, advantageously near the route of the hoisting apparatus, that is, at such a distance, for example, that an imaging device provided in connection with the hoisting apparatus may identify it, an object that is identifiable based on its graphical properties may be placed. Such objects identifiable based on their graphical properties may comprise, for example, graphical patterns that may be formed with, for example, stickers, plates, paintings, or other methods known per se. The graphical patterns may be provided in the vicinity of the route of the hoisting apparatus either specifically for the purposes disclosed, or they may provided in the surroundings of the hoisting apparatus for other purposes. This object, identifiable based on its graphical properties, may in such a cased form at least one of said identifiable objects. The running platform of the hoisting apparatus may comprise ground, a floor, a track of the hoisting apparatus, or another similar platform on which the hoisting apparatus may be adapted to travel.

In an embodiment, at least one of the identifiable objects 8 comprises a fastening member of the track of the hoisting apparatus. Such an identifiable object may, depending on the embodiment, thus be, for example, an object not defined in advance, a reference point known in advance and/or an object identifiable based on its graphical properties. The fastening member of the track may comprise, for example, a lug, bolt head, or another fastening member known per se.

In an embodiment, the processing means 5 may be adapted to identify two or more identifiable objects from at least two images saved at different time instants. This may improve the accuracy and reliability of the speed and direction of travel as well as the position data of the hoisting apparatus, because the data may be determined and computed separately based on the two or more identifiable objects and the values thus obtained may be compared with each other. The processing means 5 and/or the control unit of the hoisting apparatus may be adapted to carry out measures, if the defined values do not match each other accurately enough, such as to re-determine the travel speed and direction of the hoisting apparatus and/or to provide a notification to the operator.

The definition of the travel speed and direction of the hoisting apparatus 1, carried out by the processing means 5 on the basis of the position of at least one identifiable object in at least two images produced and/or saved by at least one imaging device at different time instants may in different embodiments be carried out in different ways. In an embodiment, the definition may be based on an image comprising distance data relating to the image points in a three-dimensional coordinate system, whereby the position of the identified object in relation to the hoisting apparatus may be determined on the basis of the distance data of the image points representing the identified object in the three-dimensional coordinate system. In this case, the travel speed and direction of the hoisting apparatus may be easily determined on the basis of a change in the mutual three-dimensional distance data of the hoisting apparatus and the identifiable object when the time between the moments of saving the images is known.

In an embodiment, the processing means 5 may additionally be adapted to utilize the determined travel speed of the hoisting apparatus and/or the calculated position data of the hoisting apparatus for synchronising the operation of the various parts of the hoisting apparatus. The synchronisation of the different parts of the hoisting apparatus 1 may comprise the synchronisation of travel speed of the vertical support structures 2 of the hoisting apparatus, that is, the legs of the hoisting apparatus. The so-called driving aslant of the hoisting apparatus 1, in connection with which the vertical supports structures 2, that is, the legs of the hoisting apparatus do not travel at a mutually same speed, and therefore the horizontal support structure 3, so the main support, of the hoisting apparatus does not travel straight, is a common problem with movable hoisting apparatuses 1 such as portal cranes. The driving aslant causes, among other things, wear and tear of the wheels of the hoisting apparatus. In such an embodiment, at least one imaging device 4 may in each case be provided in connection with the vertical support structure 2 of each hoisting apparatus, and the processing means 5 may be adapted to determine separately the travel speed and direction and/or position data of each vertical support structure, so the leg of the hoisting apparatus. When an unintentional difference is detected in the speed, direction and/or position of the vertical support structures 2 of the hoisting apparatus, the processing means 5, such as the control unit of the hoisting apparatus, may be adapted to issue instructions to the actuators of the hoisting apparatus to synchronise the travel of the vertical support structures 2 and/or to restore the straight position of the horizontal support structure 3.

Depending on the embodiment, the arrangement and/or hoisting apparatus may comprise a separate processing unit 5 for each imaging device and/or part of the hoisting apparatus, the speed and/or direction of which is to be determined and/or position data computed, or the image data of a plurality of parts and/or imaging devices is processed with the same processing means 5 described in this specification.

In an embodiment, the processing means 5 may be adapted to utilize the determined travel speed of the hoisting apparatus and/or the calculated position data of the hoisting apparatus for the identification of loads handled by the hoisting apparatus and/or for stock accounting related to the loads handled by the hoisting apparatus.

In an embodiment, the processing means 5 may be adapted to utilize the determined travel speed of the hoisting apparatus and/or the calculated position data of the hoisting apparatus for parking the hoisting apparatus in relation to the load being handled and/or for gripping the load.

In an embodiment, at least one imaging device 4 may comprise at least one camera provided in connection with the hoisting apparatus, the images saved by which are additionally used for at least one other purpose. In other words, the at least one imaging device 4 described in this specification may in such a case comprise a camera or another imaging device already provided, or to be provided, in connection with the hoisting apparatus for another purpose. In such a case, the same imaging device may be utilized for a plurality of purposes, such as load handling, controlling the hoisting apparatus and/or synchronising the various parts of the hoisting apparatus.

The at least one imaging device 4 provided in connection with the hoisting apparatus 1 may be provided in a fixed part of the hoisting apparatus, such as the body of the horizontal support structure 3 or the vertical support structure 2 of the hoisting apparatus, in connection with the top or bottom end of the vertical support structure, for example. In addition to or instead of this, the at least one imaging device 4 provided in connection with the hoisting apparatus 1 may be provided in a part provided movably in relation to the horizontal support structure 3 and/or the vertical support structure 1 of the hoisting apparatus, such as a trolley or another moving part.

FIG. 4 show a method in connection with a movable hoisting apparatus. In this method, images may in the first place be saved 41 by at least one camera provided in connection with a movable hoisting apparatus, the images at least partly presenting the surroundings of the hoisting apparatus. In the processing means, at least one identifiable object may be identified 42 from at least two images saved at different time instants. Further in the processing means, the travel direction and speed of the hoisting apparatus may be determined 43 on the basis of at least the position of the identifiable object in said at least two images saved at different time instants.

In an embodiment, the method allows the computation of the position data of the hoisting apparatus by integrating the travel speed of the hoisting apparatus, determined in the processing means.

In the different embodiments, the method may be implemented by an arrangement and/or hoisting apparatus disclosed in this specification.

One embodiment relates to a computer program product containing a computer-executable program code to be executed on a computer, which, when executed on the computer, provides operations according to the solutions disclosed in this specification. The computer program may be executed on a computer or processing means, provided in connection with the hoisting apparatus. The computer program may be in a source code form, an object code form or an intermediate form, and it may be stored in some kind of a transmission means, which may be any entity or device capable of storing the program. Such transmission means comprise for instance a storing medium, computer memory, read-only memory, electric carrier wave, data communications signal and software distribution package. The memory may be non-volatile or volatile memory, as described above.

In an embodiment, the movable hoisting apparatus may comprise an arrangement described in this specification in connection with the movable hoisting apparatus. In such a case, at least one imaging device and processing means may have been provided in connection with the movable hoisting apparatus. In an embodiment, the disclosed processing means 5 form the control unit, or part thereof, of the movable hoisting apparatus.

A person skilled in the art will find it obvious that, as technology advances, the basic idea of the invention may be implemented in many different ways. The invention and its embodiments are thus not restricted to the above-described examples but may vary within the scope of the claims.

1.-15. (canceled)

16. An arrangement in connection with a movable hoisting apparatus, an entirety of the hoisting apparatus being movable in relation to the operating environment and running platform and comprising at least one vertical support structure acting as a support leg of the hoisting apparatus, the arrangement comprising at least one imaging device and a processor provided in connection with the hoisting apparatus,
wherein said at least one imaging device is adapted to save images, which at least partly present the surroundings of the hoisting apparatus,
wherein said processor is adapted to identify at least one identifiable object from at least two images saved at different time instants and to determine the direction and speed of travel of the hoisting apparatus based on at least the position of the identifiable object in said at least two images saved at different time instants, and
wherein at least one of the imaging devices is provided in each case in connection with the vertical support structure of the hoisting apparatus, and the processor is adapted to determine separately the travel speed and direction of each vertical support structure to utilize the determined travel speed of the hoisting apparatus for synchronising the travel speed of the vertical support structures.

17. The arrangement as claimed in claim 16, wherein the processor is additionally adapted to calculate the position data of the hoisting apparatus by integrating the determined speed of the hoisting apparatus.

18. The arrangement as claimed in claim 16, wherein at least one identifiable object comprises an object not predefined.

19. The arrangement as claimed in claim 16, wherein at least one identifiable object comprises a reference point known in advance, and the processor is adapted to calibrate the position data of the hoisting apparatus by utilizing the identification of the reference point known in advance and a known position of the hoisting apparatus in the usage environment.

20. The arrangement as claimed in claim 16, wherein the arrangement further comprises at least one object identifiable on the basis of graphical properties thereof, which is provided on the running platform of the hoisting apparatus in the travel area of the hoisting apparatus in the vicinity of the route of the hoisting apparatus, whereby the at least one object, identifiable based on the graphical properties, forms at least one of said identifiable objects.

21. The arrangement as claimed in claim 16, wherein at least one of the identifiable objects comprises a fastening member of the track of the hoisting apparatus.

22. The arrangement as claimed in claim 19, wherein at least one of the identifiable objects comprises a unique reference point whose position is unambiguously identifiable.

23. The arrangement as claimed in claim 16, where the processor is adapted to utilize the determined travel speed of the hoisting apparatus and/or the calculated position data of the hoisting apparatus for synchronising the operation of the various parts of the hoisting apparatus.

24. The arrangement as claimed in claim 16, wherein the processor is adapted to utilize the determined travel speed of the hoisting apparatus and/or the calculated position data of the hoisting apparatus for the identification of loads handled by the hoisting apparatus and/or for stock accounting related to the loads handled by the hoisting apparatus.

25. The arrangement as claimed in claim 16, wherein the processor is adapted to utilize the determined travel speed of the hoisting apparatus and/or the calculated position data of the hoisting apparatus for parking the hoisting apparatus in relation to the load being handled and/or for gripping the load.

26. The arrangement as claimed in claim 16, wherein at least one imaging device comprises at least one camera provided in connection with the hoisting apparatus, the images saved by the at least one imaging device being additionally used for at least one other purpose.

27. The arrangement as claimed in claim 16, wherein the processor is adapted to determine separately a position data of each vertical support structure of the hoisting apparatus.

28. A movable hoisting apparatus, an entirety of the hoisting apparatus being movable in relation to the operating environment and running platform, and comprising the arrangement as claimed in claim 16.

29. A method in connection with a movable hoisting apparatus, an entirety of the hoisting apparatus being movable in relation to the operating environment and running platform and comprising at least one vertical support structure acting as a support leg of the hoisting apparatus, wherein the method comprises:
providing at least one of the imaging devices in connection with each vertical support structure of the hoisting apparatus;
saving images by at least one camera provided in connection with the movable hoisting apparatus, the images at least partly presenting the surroundings of the hoisting apparatus;
identifying in a processor at least one identifiable object from at least two images saved at different time instants;
determining in said processor the travel direction and speed of the hoisting apparatus on the basis of at least the position of the identifiable object in said at least two images saved at different time instants; and
determining in said processor separately the travel speed and direction of each vertical support structure to utilize the determined travel speed of the hoisting apparatus for synchronising the travel speed of the vertical support structures.

30. The method as claimed in claim 29, wherein the position data of the hoisting apparatus is further calculated by integrating the travel speed of the hoisting apparatus, determined in the processor.

31. The method as claimed in claim 29, wherein at least one imaging device provided in connection with the hoisting apparatus comprises at least one camera provided in connection with the movable hoisting apparatus for another purpose.
